(19) United States
(12) Patent Application Publication
(10) Pub. No.: US 2013/0339464 A1
(43) Pub. Date: Dec. 19, 2013

(54) CONTACT AND IDENTITY MANAGEMENT IN A HETEROGENEOUS NETWORK WITH DISPARATE CLIENTS

(71) Applicants: Rouzbeh Moazami Goudarzi, Los Gatos, CA (US); John K. Thomas, Saratoga, CA (US); Keith Thomas Sherry, Los Gatos, CA (US); Carl W. Werner, Los Gatos, CA (US)

(72) Inventors: Rouzbeh Moazami Goudarzi, Los Gatos, CA (US); John K. Thomas, Saratoga, CA (US); Keith Thomas Sherry, Los Gatos, CA (US); Carl W. Werner, Los Gatos, CA (US)

(73) Assignee: RAMBUS INC., Sunnyvale, CA (US)

(21) Appl. No.: 13/996,443

(22) PCT Filed: Dec. 13, 2011
(86) PCT No.: PCT/US2011/064680

§ 371 Date: Jun. 20, 2013

Related U.S. Application Data
(60) Provisional application No. 61/426,047, filed on Dec. 22, 2010.

(51) Int. Cl. H04L 29/06

(52) U.S. Cl. CPC H04L 65/1069
USPC 709/206; 709/227

(57) ABSTRACT

The present disclosure describes one embodiment of an operating center server for managing contact information and user identifiers of users who communicate with others using a plurality of different communication platforms that operate on disparate networks (e.g., a cellular network or a wireless local area network). The operating center server converges cellular connectivity services (e.g., cellular calls or SMS messages) with internet protocol (IP) services (e.g., email or VOIP calls) and provides these services to terminal devices regardless of the specific network connectivity available to the devices.

### BACKGROUND

The present disclosure relates to client-server management of contact information and user identities.

In the present age, communication between people may be performed using a vast array of different types of communication platforms. People may communicate with one another via circuit switched phone calls, email, voice-over internet protocol (VOIP) calls, and short message service (SMS) messages, for example. People that communicate using these different types of communication platforms typically have multiple public or private identities representing subscriptions to the various services or organizations that provide the communication platforms. Due to the number of identities that may represent a person, management of these identities is becoming increasingly more difficult.

### BRIEF DESCRIPTION OF THE DRAWINGS

The teachings of the embodiments of the present disclosure can be readily understood by considering the following detailed description in conjunction with the accompanying drawings.

FIG. 1 illustrates a network system including an operating center server for managing disparate user identities across disparate networks and services, according to one embodiment.

FIG. 2 illustrates the various functional software modules of the operating center server for contact management, according to one embodiment.

FIG. 3 illustrates an example of a user profile, according to one embodiment.

FIG. 4 illustrates an example of a contact policy, according to one embodiment.

FIG. 5 illustrates a method for updating user contact information, according to one embodiment.

FIGS. 6A and 6B are interaction diagrams illustrating communication between clients of disparate terminal devices operating on disparate networks, according to one embodiment.

FIG. 7 illustrates a method of the operating center server for establishing a cellular or WLAN communication path between terminal devices, according to one embodiment.

FIG. 8 illustrates the various functional software modules of the operating center server, according to one embodiment.

FIG. 9 illustrates the various functional software modules of the terminal device, according to one embodiment.

FIG. 10 illustrates the hardware architecture of the operating center server, according to one embodiment.

FIG. 11 illustrates the storage module of the operating center server storing various functional software modules for contact management, according to one embodiment.

FIGS. 12A, 12B, 12C, and 12D illustrate various menus of a user interface of a client application, according to one embodiment.

### DETAILED DESCRIPTION OF EMBODIMENTS

The present disclosure describes an operating center (OC) server for managing contact information and user identities of users who communicate with others using a plurality of different communication platforms that operate on disparate networks (e.g., a cellular network or a wireless local area network (WLAN)). Examples of the different communication platforms are circuit switched phone calls, email, VOIP calls, and SMS messages. The OC server converges cellular connectivity services (e.g., cellular calls or SMS messages) with internet protocol (IP)-based communication services (e.g., email or VOIP calls) and provides these services to terminal devices regardless of the specific network connectivity available to the devices.

According to one embodiment, the OC server maintains or stores user profiles that describe user contact information. In one embodiment, a user's contact information represents the various identities of the user on the services or organizations that provide the communication services used by the user. For example, a user profile may comprise a plurality of communication identifiers such as the user's email address, cellular phone number, home phone number, or a user name for VOIP call service. Each identifier represents the identity of the user in the communication service associated with the identifier. Furthermore, the contact information included in a user profile implicitly indicates the type of terminal devices by which the user may be contacted. For example, by having a user name for VOIP call service (i.e., a handle), the user profile indicates that the user can be contacted using a VOIP phone or service.

In one embodiment, the OC server also stores contact policies for users. A contact policy comprises a user's contact preferences that describe the manner in which the user may or may not be contacted and by whom. The contact policies also describe how users are generally presented to specific users or for specific types of communication. That is, the contact policies describe how a user's identity should be exposed to the user's different contacts when communication is established. For example, a user may only expose a personal email address to all contacts rather than expose all of his or her different identities (e.g., cell phone number, instant messenger (IM) handle, and work email address).

In one embodiment, each user's profile and contact policy are synchronized with the user's terminal devices associated with the contact information in the profile. By synchronizing the user's profile and contact policy with the terminal devices, the OC server may facilitate communication with others according to the user's contact policy and allows for the convergence of the cellular connectivity services (e.g., cellular calls or SMS messages) and internet protocol (IP)-based services to which the user is subscribed.

To communicate with a contact, a client application (e.g., a software application) or user agent on a user's terminal device initiates communication with the OC server that will facilitate communication with the contact. The OC server receives a request from the client application to communicate with the contact over a first type of communication network such as a cellular network. In one embodiment, the request comprises the communication type for communicating with the contact and an identity of the contact. The communication type may be for example, a voice call, email, or SMS message. The identity of the contact may vary depending on the contact policy associated with the recipient of the communication. As mentioned above, the contact policy defines how the recipient's identity or identities are presented to his or her contacts. The policy may indicate that only a work email is exposed to recipient's contacts such as JDoe@Rambus.com, for example. One example of a communication request is “Voice call to JDoe@Rambus.com” where “Voice call” represents the communication type and “JDoe@Rambus.com” represents the identity of the person.

The example communication request described above illustrates that the identity of the recipient is decoupled from the communication type. That is, any type of identity (e.g., email address or phone number) may be used in combination with any type of communication means (e.g., email or voice call) in a request to contact a person. In other words, the identity of the recipient may be in a format that is associated with a particular type of communication that is different from the type of communication included in the request. Thus, a single identity may be used to reach a recipient via different communication platforms that operate on disparate networks.

Once the request is received, the OC server creates a session which facilitates communication with the intended recipient of the communication request. As mentioned previously, each user has an associated contact policy that describes how the user may or may not be contacted. Accordingly, the OC server accesses the contact policy for the intended recipient and determines how the recipient will be contacted. For example, the contact policy may indicate to place a cellular call to the recipient's mobile phone, transmit an email to the recipient's work email address, and/or place a VOIP call to the recipient's VOIP service identifier in response to a request to call the recipient.

Responsive to determining the communication means by which to contact the recipient, the OC server determines the identity or identities (i.e., email address, telephone number, or Skype username) to communicate with using the recipient's different terminal devices. Because the recipient's terminal devices may operate over disparate networks (i.e., mobile phone operates on a cellular network and VOIP phone operates on a WLAN) that may be different from the type of network in which the user's terminal device is operating, the OC server itself contacts each of the client applications on the recipient's terminal devices through their applicable network thereby adding the client applications on the recipient's terminal devices into a communication session with the terminal device of the user. Thus, the OC server functions as a proxy for communication between the client application on the user's terminal device and the client application on the recipient's terminal devices that operate over disparate networks.

Reference will now be made to several embodiments of the present disclosure, examples of which are illustrated in the accompanying figures. It is noted that wherever practicable similar or like reference numbers may be used in the figures and may indicate similar or like functionality. The figures depict embodiments of the present disclosure for purposes of illustration only. One skilled in the art will readily recognize from the following description that alternative embodiments of the structures and methods illustrated herein may be employed without departing from the principles of the disclosure described herein.

### System Overview

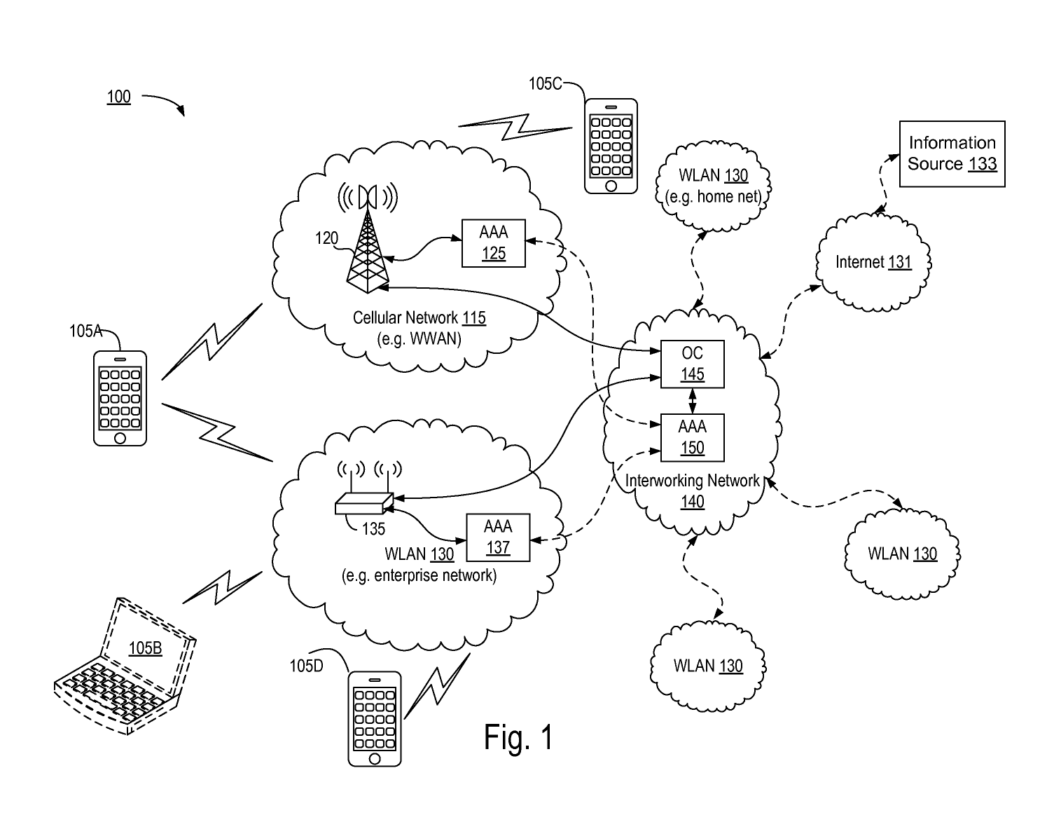

FIG. 1 depicts a network system 100 in accordance with one embodiment of the present disclosure. The network system 100 comprises an interworking network 140 in communication with terminal devices 105A, 105B, 105C, 105D (collectively or individually referred to with reference numeral 105) through cellular network 115 and/or WLANs (Wireless Local Area Networks) 130. Generally, interworking network 140 implements authentication among the multiple WLANs, and/or among one or more cellular networks, and thus allows terminal devices 105 to communicate with other devices that operate over disparate networks such as a cellular network or a WLAN. Interworking network 140 also anchors data sessions between terminal devices 105 to maintain communication between the devices. The interworking network 140 may also be in communication with an information source 133 via the Internet 131. The information source 133 may provide content such as videos, audio, text, web pages, or any other content that may be requested by a terminal device 105.

In one embodiment, interworking network 140 includes an operating center (OC) server 145 and an AAA server 150. The OC server 145 manages user contact information and user identifiers for each user registered with the OC server 145. In one embodiment, the OC server 145 facilitates communication between terminal devices 105 of users registered with the OC server 145. By managing the contact information for the users, the OC server 145 allows for users to communicate with contacts across disparate networks (i.e., cellular network 115 and WLAN 130) and services using disparate identities. That is, the OC server 145 converges cellular connectivity services (e.g., cellular calls or SMS messages) with internet protocol (IP)-based services (e.g., email or VOIP calls) and provides these services to terminal devices 105 regardless of the specific network connectivity available to the devices.

In one embodiment, users register with the OC server 145 in order to gain access to the functionality provided by the OC server 145 as described in the present disclosure. Registering with the OC server 145 may comprise downloading a client application (i.e., a user agent) to a terminal device that functions as the user interface to the OC server 145. In one embodiment, the client application may be the dialer function of a cellular phone and its associated call handling functions. Alternatively, a client application may be an application executable on a terminal device that is distinct from the dialer function. Registering with the OC server 145 may also comprise establishing an account with the OC server 145 by providing a username and password to the OC server 145. In some embodiments, payment information such as a credit card number may be required for the services provided by the OC server 145. In alternative embodiments, users are not required to register with the OC server 145.

AAA servers such as AAA server 150 are well known, so a detailed discussion is omitted. Briefly, the first “A” stands for authentication, which refers to the process performed by AAA server 150 of verifying a terminal device's claim to holding a specific digital identity, and typically involves providing credentials in the form of passwords, tokens, digital certificates, or phone numbers. The second “A” is for authorization, and is more properly termed “access control.” This functionality of the AAA server 150 grants or refuses access privileges. For example, a WLAN may grant a given terminal device access to the Internet but deny access to a proprietary database. Finally, the last “A” is for “accounting,” which refers to the tracking of the consumption of network resources, typically for purposes of billing. AAA servers are alternatively referred to herein as “authentication” servers, as some embodiments may dispense with other functionality.

In one embodiment, a terminal device 105, such as a cellular phone, communicates with the interworking network 140 through a cellular network 115. In this example, terminal device 105A belongs to a user who has an account with a cellular provider that maintains the cellular network 115, or wireless wide-area network (WWAN), which conventionally includes cellular towers 120 and an AAA server 125. AAA server 125 is similar to AAA server 150 described above and performs similar functionalities. Towers 120 provide for wireless communication between terminal device 105A and cellular network 115, while AAA server 125 controls which terminal devices 105 have access to network 115, what level of service they receive, etc.

In one embodiment, terminal device 105B, such as a computer, may also communicate with the interworking network 140 through WLANs 130. Each WLAN 130 provides for wireless communication over an area that is limited relative to what is typically provided by cellular network 115. In this example each WLAN 130 is independently managed, with typical examples including enterprise networks and home networks. WLANs 130 include a wireless access point (WAP) 135 and an AAA server 137 that performs functionality similar to AAA 150. WLANs 130 may communicate with terminal device 105 using a different air interface than that employed by cellular network 115, and typically provide considerably higher data bandwidth and lower cost per byte of information, albeit within a much smaller coverage area. The networks depicted as clouds in FIG. 1 can be interconnected with one another and with other networks using proprietary connections or public resources, such as the Internet.

The depicted networks subscribe to a service provided by interworking network 140, and may be referred to as private networks in this context. Interworking network 140 manages the communication between terminal devices 105 via the private networks 115 and 130, and provides a common authentication scheme to allow terminal devices 105 to communicate with one another via multiple interconnected networks.

Each of the devices and networks of FIG. 1 can include many components that have been omitted from FIG. 1 for ease of illustration. For example, terminal device 105A can be a so-called “smart phone” that includes an application/media processor and associated memory to support web access, location-based services, multimedia applications, etc. Terminal device 105A may also be any device with computing capabilities. Terminal device 105A can also include numerous interfaces in support of wireless or wired communications, which commonly include a cellular interface, an infrared port, a Bluetooth wireless port, and a Wi-Fi wireless network connection. Terminal device 105A may also include a Global Positioning System (“GPS”) receiver.

Cellular network 115 is likewise far more complex then shown, and will typically include e.g. a Radio Access Network (RAN), which typically includes base stations and controllers, and a Core Network (CN), which typically includes multiple switching entities and gateways. These and other features of terminal devices 105 and cellular network 115 are well known to those of skill in the art. A detailed treatment is therefore omitted for brevity.

### Operating Center Server

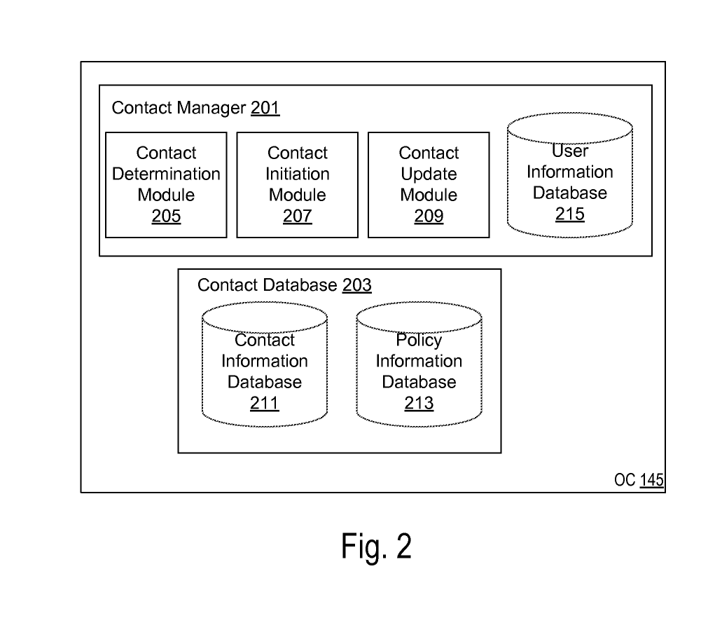

Referring now to FIG. 2, there is shown a high-level diagram illustrating the various functional software modules of the OC server 145 for contact management according to one embodiment. As shown in FIG. 2, the OC server 145 includes multiple modules that are in communication with one another. Note that other embodiments of the OC server 145 may have different and/or other modules than the ones described here, and that the functionalities can be distributed among the modules in a different manner.

As mentioned previously, the OC server 145 manages contact information and user identifiers for each user registered with the OC server 145 and facilitates communication between the terminal devices 105 of the users. According to one embodiment, the OC server 145 comprises a contact database 203. Generally, the contact database 203 maintains contact information and user identities of users registered with the OC server 145.

In one embodiment, the contact database 203 comprises a contact information database 211 and a policy information database 213. The contact information database 211 stores contact information for each registered user. The contact information may comprise the user's contacts (i.e., contact information of others) as well as the user's own personal contact information.

Due to the various types of communication platforms that are now available, the user may be contacted via different forms of communication using terminal devices that operate on disparate networks. The contact information database 211 stores for each user a profile that describes the user's personal contact information. In one embodiment, a user's contact profile describes the user's contact information that represents the various identities of the user that are used to communicate via different types of communication means such as email, SMS messaging, or VOIP calls. According to one embodiment, addressable devices such as Blu-Ray players or IP televisions may also be associated with an identity of a user.

In one embodiment, the contact information is a communication identifier such as an email address, telephone number, a message handle, or username. As mentioned previously, each communication identifier represents the user's identity in the service that provides the communication means. For example, the user's VOIP service handle represents the user's identity in the VOIP service network of users. According to one embodiment, a user profile may comprise one or more of the following exemplary communication identifiers for a user:
work email address;
personal email address;
mobile phone number;
home phone number;
work phone number;
pager number;
VOIP service username (i.e., handle);
Instant Messenger service identifier;
VOIP phone number;
social networking service username;
online gaming name

Note that any other form of contact information that may be used to contact the user other than those listed above may be included in a user profile. Additionally, the user profile may comprise the user's avatars or user headshots that are associated with each identity. In one embodiment, an avatar may be the user's computer representation in the form of a three-dimensional model or a two-dimensional icon or picture presented to other users of a particular communication service. For example in the context of an Instant Messenger message to a recipient, in addition to presenting username to the recipient of the message, a picture of the user (i.e., an avatar) may also be presented. Furthermore, the user profile may comprise one or more voice-overs that modify the user's voice to produce an alternative voice such as a cartoon character voice.

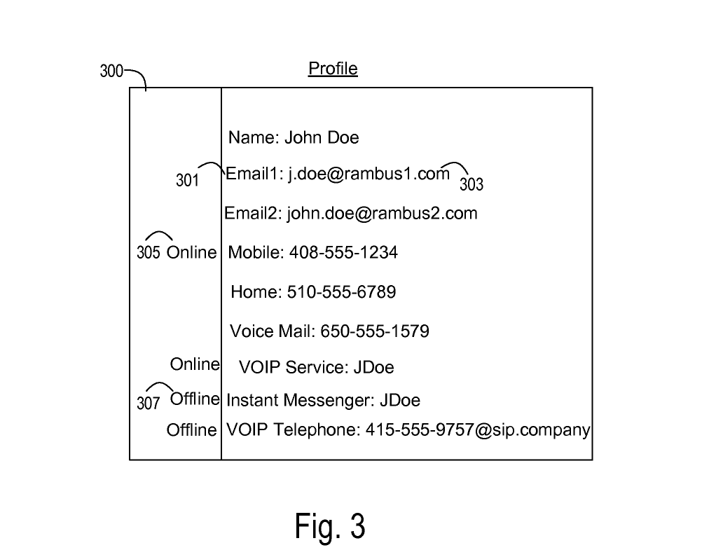

Referring now to FIG. 3, there is shown one example of a user profile for user “John Doe” according to one embodiment. The user profile comprises a list of contact fields that describe the types of communication that may be used to contact the user identified by the profile, and is stored in contact information database 211 (FIG. 2). Each contact field has an associated contact value. The contact value describes the communication identifier associated with the type of communication specified by the contact field. As mentioned above, the contact value describes the user's identity in the service that provides the type of communication associated with the contact field. For example, contact field 301 is associated with email communication and the contact value 303 “j.doe@rambus1.com” represents the address of an email box provided by an email service in which the user's email is delivered. In one embodiment, the contact value is also associated with a credential, certificate, or password that allows access to the communication means associated with the contact value thereby preventing unauthorized access to the communication means.

In one embodiment, the user profile further comprises a device status for the terminal devices associated with the contact information where applicable. As previously discussed, according to one embodiment, the user's terminal devices may comprise a client application that is used to interface with the OC server 145. The client application may communicate with the OC server 145 to indicate the status of the device. By communicating with the terminal device, the OC server 145 is aware if the device is “online” or “active.” In one embodiment, a device is online if the device is able to communicate with the OC server 145 via the cellular network 115 and/or the WLAN 130. In alternative embodiments, to determine which terminal devices 105 are active, the OC server 145 may poll the client executing on each device. If a response is received from the client of the terminal device 105 being polled, the OC server 145 determines that the terminal device is active.

In the example profile 300, the profile 300 indicates that the user's mobile phone is currently online 305. That is, the mobile phone currently is capable of communicating with the OC server 145. In contrast, the user's IM messager is currently offline 307 indicating that the user is not currently signed onto the instant messager service.

By having knowledge of active devices, the OC server 145 may provide different portions of communication, such as audio and video, using one or more devices. For example, if a user has requested to have a video chat with a recipient, but the user's computer is currently not active, the OC server 145 may determine how to facilitate the communication based on the recipient's active devices. The OC server 145 may determine that the recipient's IP television is currently active as well as the recipient's cellular phone. The OC server 145 then may facilitate communication between the user and recipient by directing audio to the recipient's cellular phone while providing video to the recipient's IP television.

Referring back to FIG. 2, in one embodiment the contact database 203 also comprises a policy information database 213. The policy information database 213 comprises contact policies for users. Each contact policy is associated with its corresponding user profile stored in the contacted information database 211. In one embodiment, a user's contact policy comprises the user's preferences describing how the user is presented to his or her contacts as well as the manner in which the user may or may not be contacted. Note that in other embodiments a contact policy may also comprise preferences other than those described below.

As mentioned above, typically a user is associated with multiple identities (e.g., email, IM username, VOIP service username, etc.) and may not want to expose all the user's identities to every contact. The contact policy may comprise a specific identity that the user allows exposure to all of his or her contacts. For example, the user may only want to expose an email address or a telephone number to his or her contacts which may be considered a “public” identity. In another example, an employee may want to receive calls from co-workers or work clients on his or her cellular phone, but only expose his or her employer's phone number as his or her identity. In one embodiment, the contact policy may expose a specific identity to specific contacts. For example, the user may only expose a work email address to colleagues from work or may expose the identity “Dad” to his children or may expose the identity “BatmanForever” only to contacts that are part of a particular online gaming community. These identities are considered “Private” identities. Thus, in a user's contact list, each contact in the list is presented in the user's contact list based on the preferences indicated in the policy of the user's contact. Additionally, during communication, each user is presented to his or her contacts in a manner that is specified by the user's contact policy.

The contact policy also describes the communication mechanism(s) in which the user is contacted by his or her contacts. In one embodiment, the contact policy describes which communication mechanisms are used to contact the user based on the communication type initiated by a contact. For example, the user may indicate a preference that for any calls (i.e., the communication type) directed to the user's exposed identity, the user's mobile phone, home phone, work phone and VOIP telephone are called and an email is sent to the user's personal email address. Alternatively, the user may indicate a preference that any incoming emails should be sent to a specific email address. Furthermore, the contact policy may also describe specific actions to contact a user such as forwarding incoming voice communications directed to the user to a specific voice mail box associated with the user or to collect incoming email messages at a specific email server.

In one embodiment, the contact policy may also include a preference describing who is allowed to communicate with the user. The contact policy may allow all of the user's contacts to communicate with the user, but not allow any calls to/from specific numbers such as “900” or “976” numbers or to/from domains such as a firewall for user's phone. Thus, the contact policy may restrict any incoming communication from specific telephone numbers, email addresses, or domain addresses, or user identities.

The contact policy may also describe which types of communication are allowed or prohibited to be performed from a terminal device. For example, a mobile phone may only allow outgoing calls to a user's parents if the user is a child. In this example, the OC server 145 operates as a communication nanny for children any may only allow outgoing calls to all identities for “Mom.” Alternatively, the policy may indicate that only outgoing emails from a work computer or work mobile phone may be sent to an email address comprising a work domain address (e.g., @Rambus.com) to ensure that emails are work related.

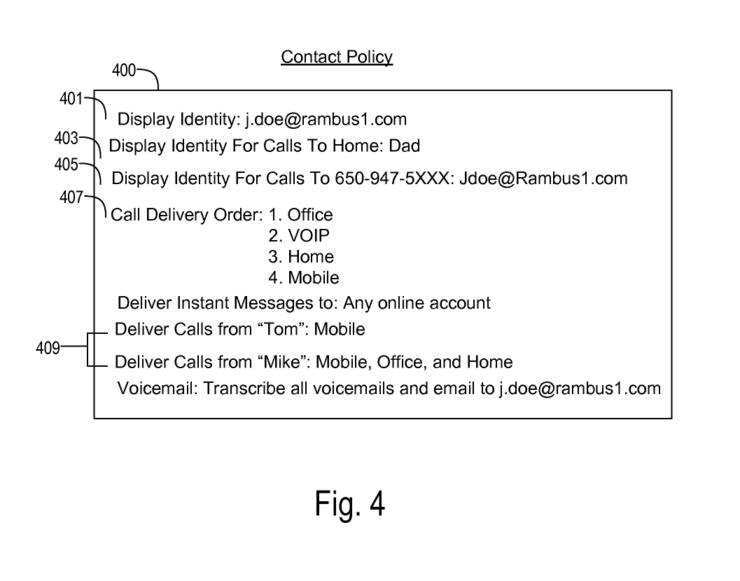

Referring now to FIG. 4, there is shown an example contact policy 400 according to one embodiment. The contact policy 400 illustrates examples of contact preferences for the user associated with the policy. In contact policy 400, the user set the display handle preference 401 so that the identity “j.doe@rambus1.com” is exposed to the user's contacts. The contact policy 400 also indicates a display identity preference for a specific scenario. In this example, the display identity preference 403 indicates to display the identity of “Dad” for any calls to the user's home telephone number. Additionally, a display preference 405 indicates to display the identity “Jdoe@Rambus1.com” for any calls to the number 650-947-5XXX. Note that in other embodiments, the exposed identity may be completely hidden and may not include any notion of the communication means used to contact the user. For example, the displayed identity may be “Email Jdoe or Call Jdoe” thereby providing no insight into a communication means associated with the user.

The contact policy also includes a call delivery order preference describing the order in which calls should be placed to the user. In this example, call delivery order preference 407 indicates that all calls should be sent to the user's office telephone number, VOIP service account, home telephone, and mobile cell phone number in that order. Furthermore, the contact policy describes preferences with respect to communication from certain contacts 409. In this example, all calls from the identity “Tom” are only sent to the user's mobile device whereas calls from the identity “Mike” are sent to the user's mobile device, office telephone number, and home phone number.

Referring back to FIG. 2, the OC server 145 further comprises a contact manager 201. The contact manager 201 facilitates communication between users according to the user profiles and contact policies maintained by the contact database 203. In one embodiment, the contact manager 201 comprises a contact determination module 205, a contact initiation module 207, a contact update module 209, and a user information database 215.

The contact determination module 205 determines the communication mechanism(s) in which to contact a user based on the user's contact policy and user profile. Responsive to receiving a request to communicate with one of a user's contacts, the contact determination module 205 accesses the user's profile and contact policy. From the user's contact policy, the contact determination module 205 determines which communication mechanism(s) should be used to communicate with the contact. For example, the contact policy for the recipient of the communication may specify to call the recipient's mobile and work phones. The contact determination module 205 then accesses the user profile of the recipient to determine the communication identifiers associated with the mobile and work phones.

As mentioned above, in one embodiment only a single identity of the user may be exposed based on the recipient's contact policy such as an email address. Thus, the communication request may be in the form “Call j.doe@rambus1.com” or “Email 650-947-5000” or “IM Jdoe111” where Jdoe111 is an Online Gaming Community user name. Because only a single identity (i.e., the email address j.doe@rambus1.com, the telephone number 650-947-5000, or the online gaming community user name Jdoe111) for the recipient is exposed, but several communication mechanisms may exist to contact the recipient associated with the identity, the format of the identity is decoupled from the communication mechanism associated with the identity. In the first example above, the identity is in the form of an email address (j.doe@rambus1.com), but a request for communication with the user associated with the identity may be a request to call the email address, which is translated by contact determination module 205 to a request to a call a telephone number associated with the user that is not exposed to other users based on the contact policy.

The contact initiation module 207 initiates communication between terminal devices according to one embodiment. In one embodiment, a first client on the initiating terminal device 105 communicates with a second client the recipient's terminal device through the OC server 145. The OC server 145 communicates with the second client on the recipient's terminal device through either the cellular network 115 or the WLAN 130. Once the OC server 145 has established communication with the second client, the recipient's terminal device is added to a conference comprising the initiating terminal device thereby allowing communication between the devices. Whether the cellular network or WLAN 120 is utilized depends on what form of communication is used to contact the recipient. By having the OC server 145 communicate with the second client on the recipient's terminal device, the OC server 145 functions as a proxy for communication between the initiating terminal device and the recipient's terminal device.

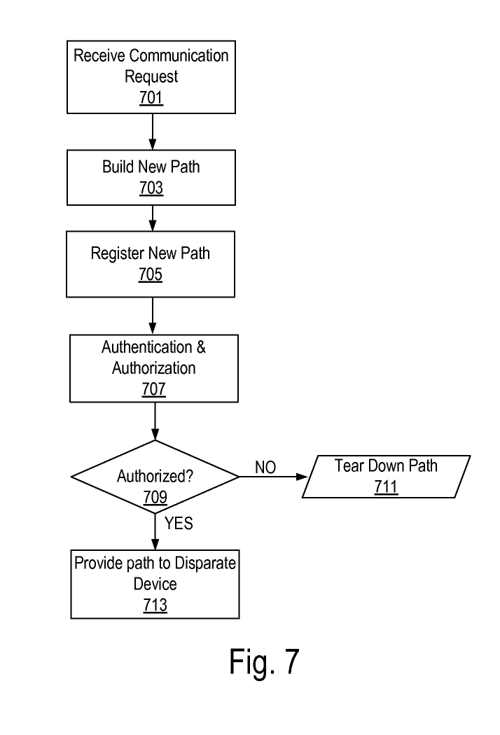

For example, if the recipient's policy states to call the recipient via a VOIP service, the OC server 145 establishes a communication path through a WLAN 130. In another example, if the recipient's policy states to call the recipient's mobile phone, a communication path through the cellular network 115 is created. Creation of a communication path will be described in further detail with respect to FIGS. 7 through 9.

In alternative embodiments, the first client on the initiating terminal device contacts a second client on a recipient's terminal device based on communication mechanisms suggested by the OC server 145. Rather than the OC server 145 acting as a proxy, the contact initiation module 207 provides a message to the first client that includes at least one suggestion of a communication mechanism in which to contact the recipient (e.g., “Call Mobile Phone”) according to the recipient's contact policy and availability. The identity of the user that is associated with the communication means may or may not be exposed based on the user's contact policy. The user then selects the communication mechanism which causes the first client to contact a second client on the selected communication means provided by the OC server 145. Thus, in this embodiment, the involvement of the OC server 145 in the communication between the user and recipient is minimized.

The contact update module 209 updates contact information. The contact update module 209 pushes updates to contact information to users of the OC server 145. In one embodiment, responsive to a user updating the contact information stored in his or her profile, the contact update module 209 pushes (i.e., sends) the updated information to his or her contacts according to the user's contact policy. That is, the contact information for the user is updated at the terminal devices of the user's contacts. For example, if the OC server 145 receives an update to a user's profile modifying the identity (e.g., an email address) that is exposed to the user's contacts, the contact update module 209 transmits the modification to the user's contacts so that user is presented to the contacts in the future using the new identity.

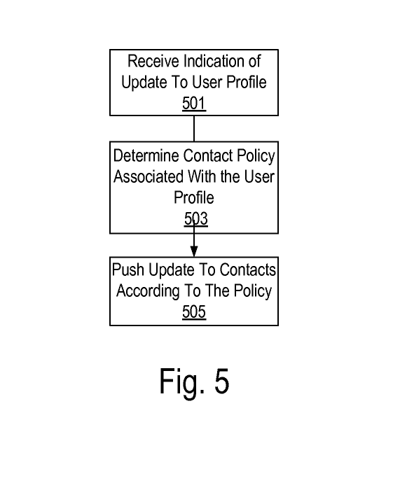

Referring now to FIG. 5, there is shown a method for pushing out user profile updates to a user's contacts (i.e., the people in the user's contact list such as the user's friends, family, or business colleagues) according to one embodiment. Note that in other embodiments, additional steps may be performed other than those described in the present disclosure.

In one embodiment, the contact update module 209 receives 501 an indication from the contact database 203 that a user's profile has been updated by the user. For example, the user may have modified his or her profile to include a new email address. The modification to the user profile causes the contact database 203 to send an indication to the contact update module 209 that the user's profile has been updated.

Responsive to receiving the indication, the contact update module 209 determines 503 the contact policy associated with the user profile. In other embodiments, the contact update module 209 may query the contact database 203 for any updates to user profiles. The contact update module 209 then pushes 505 the updated contact information to the user's contacts (e.g., the user's friends) according to the user's policy. That is, responsive to a first user updating his or her user profile, a contact list of a second user who is associated with the first user (i.e., the first user's contact), is updated according to the first user's contact policy.

Using the example above, the contact update module 209 may access the user's contact policy responsive to the modifications to the profile. The contact update module 209 may determine from the policy that the user's email address is only exposed to a particular category of contacts such as the user's friends. Thus, in this example the user's friends inherit the user's contact information according to the user's contact policy. Based on the determination, the contact update module 209 updates the contact information on the friends' terminal devices. That is, the terminal devices of the user's friends are updated so that the user's new email address is now exposed rather than the user's previous email address. Thus, all of the user's friends know the user's new email address without the user having to send an email to his or her friends notifying them of the new email address.

In another example, a user's primary email address may have been modified by the user and the user updates his or her user profile to reflect the update. Friends of the user do not need to be informed of the update as the contact update module 209 will take the appropriate action to update the friends' terminal devices. In other embodiments, a first user may also specify for the contact update module 209 to monitor a second user's profile for any updates. The users whose profiles are being followed may be categorized as a “people watching” category in some embodiments.

In one embodiment the contact manager 201 further comprises a user information database 215. The user information database 215 comprises user specific information. For each user, the user information database 215 may store information such as bookmarked web pages, favorite web pages (i.e., favorite URLs), favorite terminal devices for communication, and any other user specific information. As shown in FIG. 2, the user information database 215 may be included in the OC server 145. However, in alternative embodiments the user information database 221 may be located separate from the OC server 145.

### Interaction between OC Server and Terminal Devices

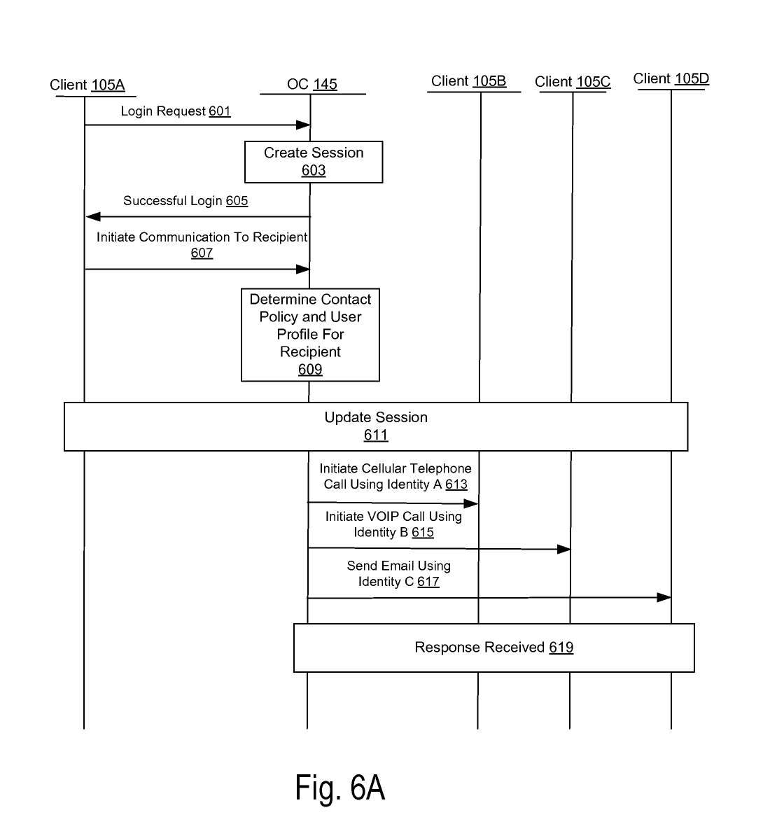

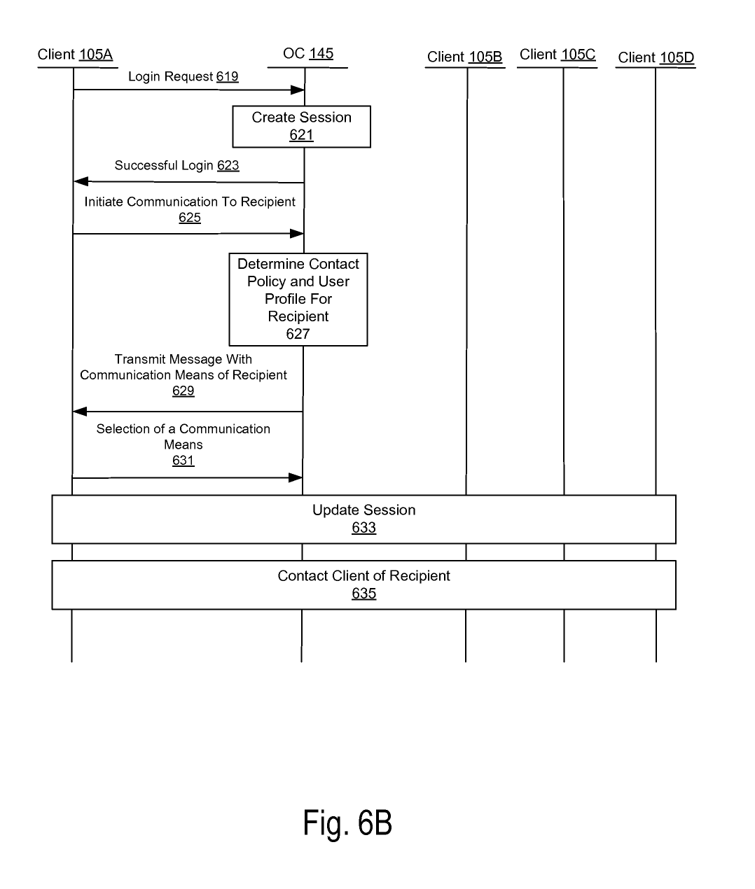

Referring now to FIG. 6A, there is shown an interaction diagram illustrating the interaction between OC server 145 and clients on terminal devices 105A through 105D responsive to the client on terminal device 105A attempting to communicate with a recipient associated with terminal devices 105B through 105D according to one embodiment. Note that in the following discussion, reference will be made to communication between the OC server 145 and the client applications of terminal devices 105 for purposes of clarity. In the following discussion, “client 105” refers to the client application on terminal device 105.

In the embodiment shown in FIG. 6A, the OC server 145 functions as a proxy for communication between the terminal devices 105 in an established session. In other embodiments, different and/or additional steps other than those performed in FIG. 6A may be performed.

In one embodiment, the client 105A transmits 601 a login request to the OC server 145. As mentioned previously, client 105 may comprise a client application that allows client 105 to interface with the OC server 145. The client 105A may transmit user login information entered into the client application to the OC server 145. Responsive to receiving the request, the OC server 145 creates 603 a session for facilitating communication between client 105A and any requested recipients. The OC server 145 indicates 605 to the client 105A a successful login.

The client 105A may initiate 607 a communication to a recipient which is received by the OC server 145 such as “Call jdoe@Rambus.com.” As mentioned previously, the recipient may only expose a single identity to his or her contacts. Because only a single identity is exposed, the communication mechanism used to contact the recipient is decoupled from the identity. The initiation of the communication may be in the form of calling an email address or emailing a telephone number, for example.

The OC server 145 receives the initiation 607 of the communication from the client 105A and determines 609 the contact policy and user profile corresponding to the intended recipient of the communication request as stored in the policy information database 213 and the contact information database 211, respectively. In one embodiment, OC server 145 determines the intended recipient from the initiation 607 of communication by client 105A and then determines the intended recipient's contact policy based on the determined identity. For example, the identity (John Doe) of the intended recipient can be determined from the initiation request “Call jdoe@Rambus1.com” as the user associated with the email address jdoe@Rambus1.com.

Also, as mentioned previously, the contact policy describes the recipient's preferences for communication. Depending on the type of communication initiated (i.e., a call, email, or SMS message, etc.) or the identity of the initiator of the communication, the OC server 145 determines the communication mechanisms in which to contact the recipient as described by the recipient's contact policy. For example, if the type of communication that is initiated is a “call” as indicated in the request “Call jdoe@Rambus1.com” the OC server 145 determines whether to call the intended recipient's (John Doe) mobile phone, VOIP phone or work phone, for example, or may determine other forms of communication by which to contact the intended recipient as specified by the policy associated with the user John Doe. In the example shown in FIG. 6A, the OC server 145 determines from the recipient's contact policy that the recipient prefers to be contacted via his or her mobile phone, VOIP phone, and/or home email (i.e., the communication mechanisms). Once the communication mechanisms are determined from the recipient's contact policy, the OC server 145 determines the identities (i.e., phone numbers or usernames, etc.) of the recipient to contact via the determined communication mechanisms from the recipient's user profile. In this example, the OC server 145 determines the recipient's mobile phone number (i.e., Identity A), VOIP number (i.e., Identity B), and home email address (i.e., Identity C) from the recipient's user profile.

The OC server 145 then updates 611 the session to include the attributes of the terminal devices associated with the determined identities. In one embodiment, the attributes include device attributes describing the types of terminal devices (e.g., mobile phone, VOIP phone, etc.) for inclusion in the session and stream attributes describing the types of streams supported by the devices (e.g., audio streams and/or video streams). In this example, the OC server 145 updates the session with the attributes of the recipient's terminal devices 105B, 105C, and/or 105D. Because the recipient may be contacted on terminal devices that operate on different networks such as cellular network 115 and/or WLAN 130, the OC server 145 contacts one or more of terminal devices 105B, 105C, and 105D through the network in which the recipient's devices operates.

In the embodiment illustrated in FIG. 6A, the OC server 145 simultaneously attempts to contact client 105B, client 105C, and client 105D according to the contact policy of the recipient. However, note that in other embodiments, the OC server 145 may sequentially attempt to contact client 105B, client 105C, and client 105D and complete the session when a response is received from at least one of the terminal devices. That is, OC server 145 may first contact client 105B and if a response is not received (e.g., the recipient fails to answer the call on client 105B), client 105C is contacted. Likewise, if a response is not received at client 105C, client 105D is contacted by the OC server 145. However, if client 105B responds, (e.g., the recipient answers the call on terminal device 105B) the session is completed and client 105C and client 105D are no longer contacted by the OC server 145.

In the embodiment illustrated in FIG. 6A, the OC server 145 initiates 613 a cellular telephone call to client 105B using Identity A using the cellular network 115. As discussed previously, the user associated with client 105A is exposed to the recipient of the communication according to the user's contact policy. Thus, the OC server 145 accesses the user's contact policy to determine how to present the user to the recipient of the communication. For example, the user's policy may only expose the user's email address to his or her contacts. Thus, the user's email address is presented on client 105B responsive to client 105B receiving the cellular call.

Additionally, the OC server 145 initiates 615 a VOIP call to Identity B using WLAN 130 or sends an email 617 to Identity C using WLAN 130. The OC server 145's facilitation of the communication between terminal devices 105 is transparent such that the user of client 105A is not aware of the presence of OC server 145. To the user of client 105A, it appears as if client 105A contacted terminal devices 105B, 105C and 105D directly. After initiating communicating with clients 105B, 105C and 105D, the OC server 145 receives 619 a response from at least one of the terminal devices responsive to the user accepting communication on the device such as the user answering the cellular call at terminal device 105B. In one embodiment, the terminal device 105 that accepted the communication is included in the session with the terminal device initiating the communication (e.g., client 105A).

Referring now to FIG. 6B, there is shown an interaction diagram illustrating another embodiment of the interaction between OC server 145 and clients 105A through 105D during communication between disparate terminal devices. In the embodiment illustrated in FIG. 6B, client 105A communicates with clients 105B through 105D without the OC server 145 acting as a proxy for communication as shown in the embodiment of FIG. 6A. Note that other embodiments may perform different and/or additional steps other than those performed in FIG. 6B. Further note that the embodiment illustrated in FIG. 6B includes similar steps as those described with respect to FIG. 6A and will therefore be discussed in brevity.

In one embodiment, the client 105A transmits 619 a login request to the OC server 145. Responsive to receiving the request, the OC server 145 creates 621 a session for facilitating communication between client 105A and any requested recipients. The OC server 145 transmits 623 an indication of a successful login to client 105A. Client 105A may then initiate 619 a communication to a recipient which is received by the OC server 145. The OC server 145 receives the initiation and respectively determines 627 the contact policy and user profile associated with the intended recipient of the communication request from the policy information database 213 and the contact information database 211. Similar to the example shown in FIG. 6A, in the embodiment illustrated in FIG. 6B, the OC server 145 determines from the recipient's contact policy that the recipient prefers to be contacted via his or her mobile phone, VOIP phone, and/or home email and determines the recipient's mobile phone number (i.e., Identity A), VOIP number (i.e., Identity B), and home email address (i.e., Identity C).

Rather than the OC server 145 initiating the communication to clients 105B through 105D, the OC server 145 transmits 629 a message to client 105A including a description of the communication means by which to contact the recipient. That is, the message comprises the method in which to contact the recipient according to the recipient's contact policy. In this example, the message may include “Cellular call to mobile phone” or “VOIP call to VOIP phone” or “Send Email.” In one embodiment, the identity associated with each communication may or may not be exposed depending on the contact policy of the recipient.

The OC server 631 receives, from client 105A, a selection 631 of a communication means included in the message. For example, the user may select “Cellular call to Mobile Phone.” The OC server 145 updates 633 the session to include the attributes of the terminal device(s) associated with the selection. The client 105A then contacts 635 the client of the recipient. In this example, client 105A may contact client 105B. Client 105A may also contact client 105C and/or client 105D in other embodiments based on the contact policy of the recipient.

In other embodiments, the OC server 145 may still facilitate communication between clients 105 when necessary. For example, if the user of client 105A selected to communicate with the recipient via “VOIP call to VOIP phone,” but terminal device 105A is not capable of communicating over WLAN 130, the OC server 145 may contact client 105C to facilitate the communication.

### Client User Interfaces

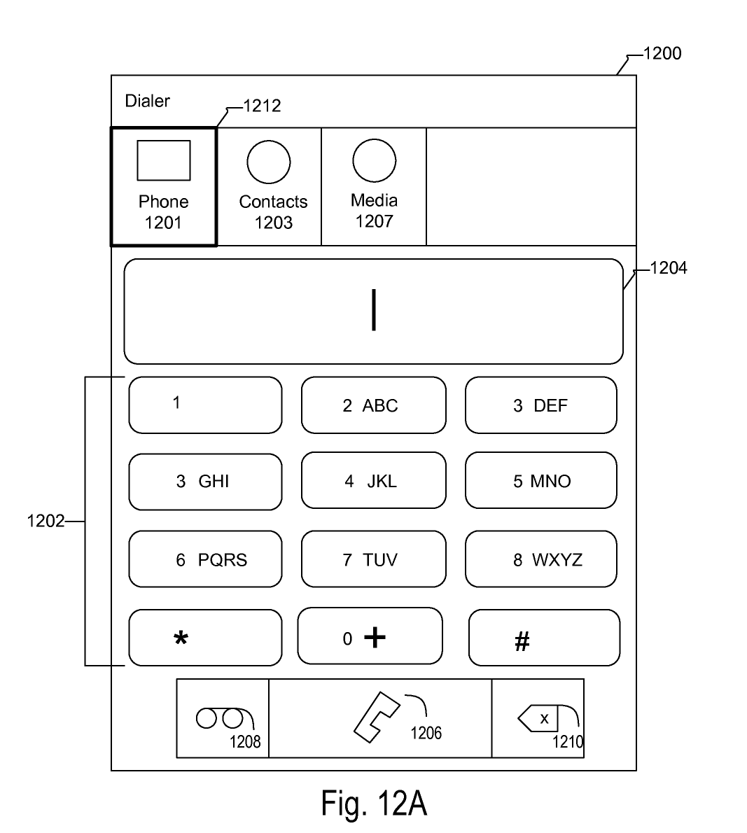

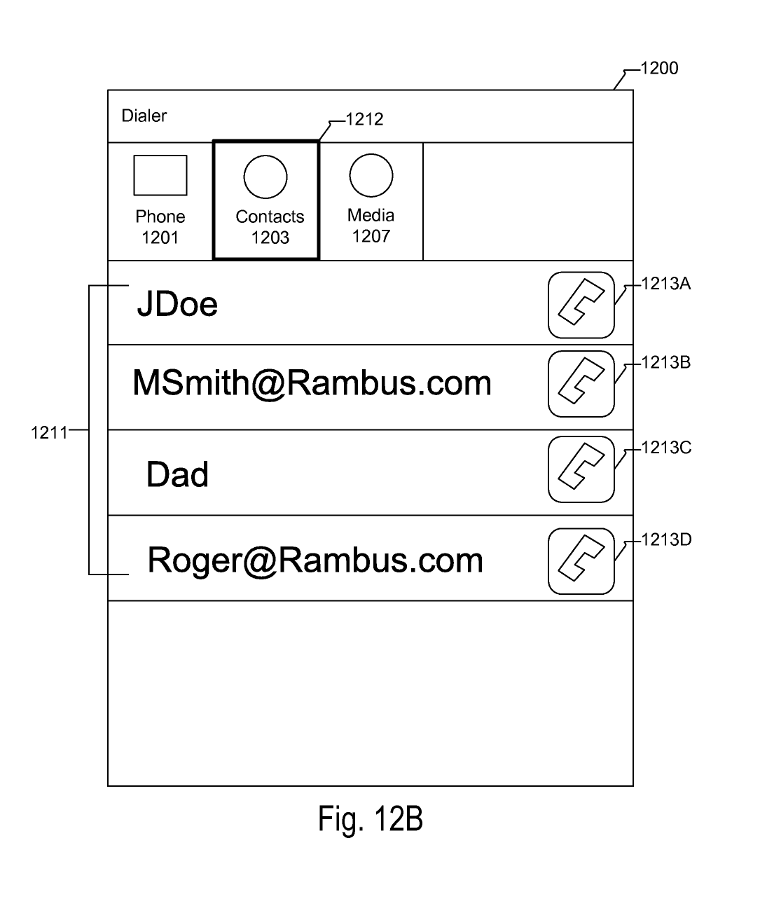

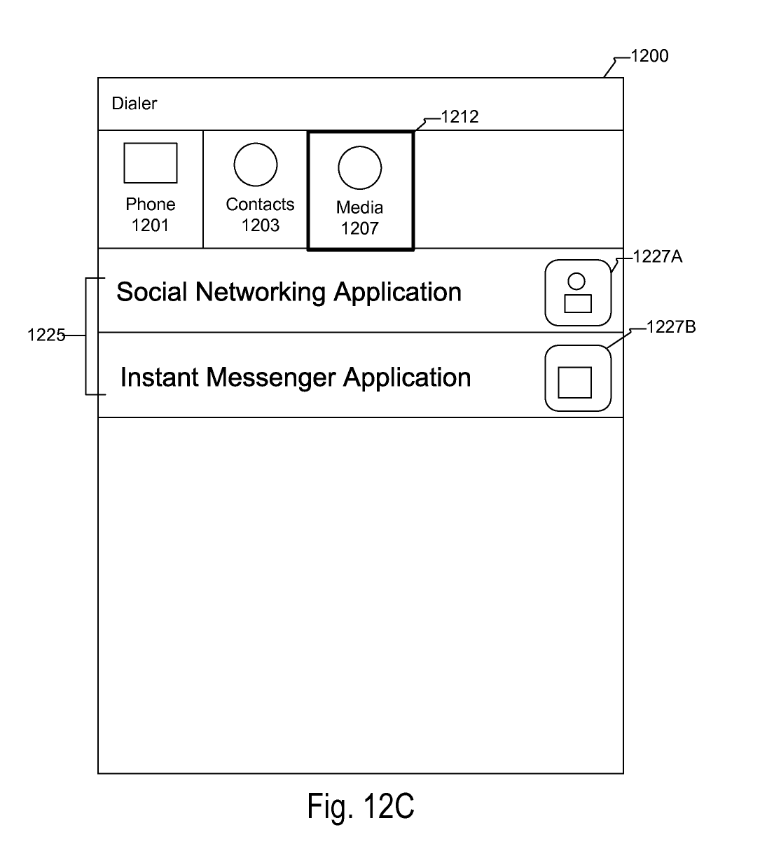

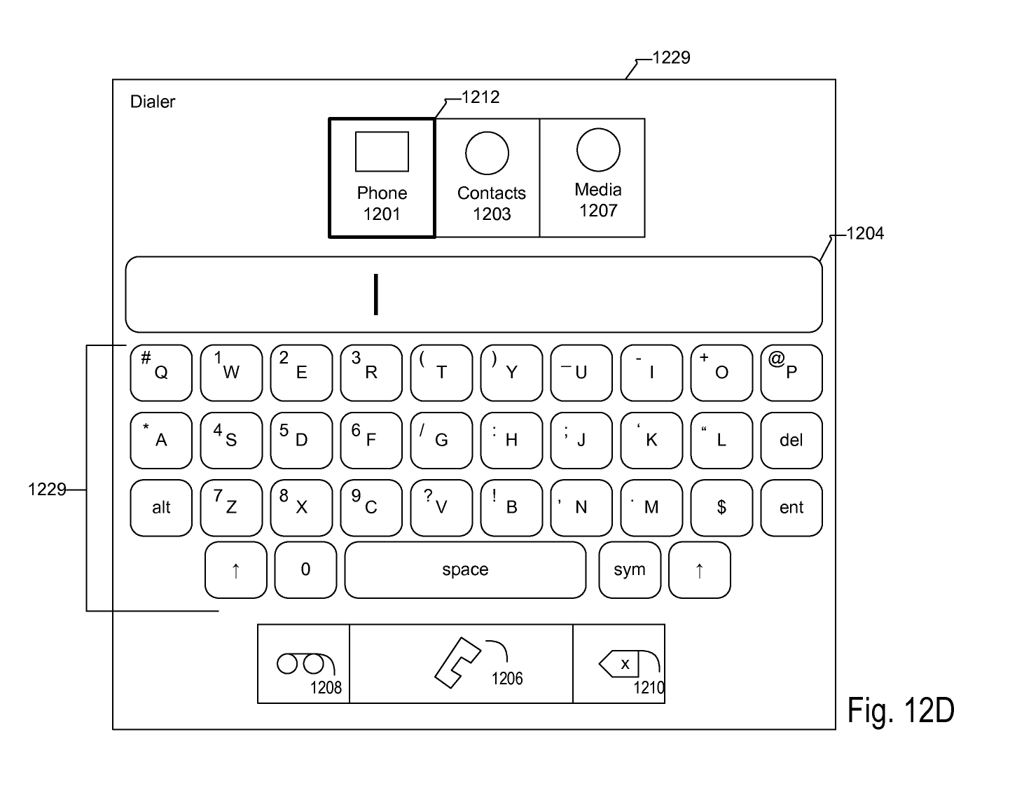

Referring to FIG. 12A, a user interface 1200 of the client application included in a terminal device 105. The user interface 1200 comprises a plurality of menu options including a phone menu option 1201, a contacts menu option 1203, and a media menu option 1207. The user of the terminal device 105 selects a menu of interest using cursor 1212. Responsive to selection of the menu, the user interface associated with the menu is illustrated to the user.

For example, selection of the phone menu option 1201 causes the user interface 1200 to display a phone menu. The phone menu comprises a keypad 1202. Any characters selected from the alphanumeric keypad 1202 are displayed in character field 1204. Additionally, the phone menu includes a dial element 1206 that causes the dialer to call any inputted number, a voice mail element 1208 to listen to received voice mails, and an end call element 1210 to end any active calls.

Responsive to the user selecting a contacts menu option 1203 using cursor 1212, the user interface 1200 displays the contacts menu as shown in FIG. 12B. The contacts menu displays the user's contact list 1211. As described previously, each contact in the contact list 1211 is displayed according to the contact's user policy. For example, the user associated with the username “JDoe” indicated in his her user profile to expose the identity “JDoe” rather than his or her name or contact information. Each of the other contacts included in contact list 1211 is also exposed per an associated user policy. Additionally, the contacts menu includes a communication initiation element (e.g., a button) 1213 that initiates communication with the contact via the OC server 145 as described above. For example, to contact JDoe, the user selects the contact communication element 1213A.

Lastly, responsive to selection of the media menu option 1207 using cursor 1212, a media menu is displayed in user interface 1200 as shown in FIG. 12C. The media menu displays to the user a list of applications 1225 available to the user. To execute (i.e., open) an application, the user presses an application UI element 1227 associated with the application. For example, to execute the social networking application, the user selects the application UI element 1227A.

Referring now to FIG. 12D, an alternative user interface 1229 of the client application included in a terminal device 105 is shown. The user interface 1229 includes similar features as those illustrated in user interface 1200 illustrated in FIG. 12A such as the phone menu option 1201, the contacts menu option 1203, the media menu option 1207 and the cursor 1212 whose description is omitted for brevity. However, note that the keypad 1229 is a QWERTY keypad rather than the alphanumeric keypad 1202 illustrated in FIG. 12A. The QWERTY keypad 1229 allows a user to contact for example “Roger@Rambus.com.”

### Communication Path Generation

FIG. 7 illustrates a method in accordance with one embodiment of the present disclosure by which interworking network 140 establishes a communication path to at least one of terminal devices 105B and 105C through cellular network 115 and/or WLAN 130. For discussion purposes, the following description is with respect to building a communication path through the WLAN 130 to communicate with client 105D but the following method may also be applied to establish a communication path through cellular network 115.

Note that in the following discussion, the interworking network 140 is assumed to have been authenticated by AAA 137 and AAA 125 and in communication with cellular network 115 and WLAN 130. In one embodiment, interworking network 140 has received a request from terminal device 105A over the cellular network 115 to place a VOIP call to terminal device 105D over WLAN 130. AAA 150 receives a communication request 701 from AAA 125 notifying interworking network 140 of the user's request to communicate with terminal device 105D. Interworking network 140 then communicates with terminal device 105D to build 703 a path between AAA 150 and terminal device 105D and registers 705 the new path. With the path established, AAA 150 communicates with terminal device 105A to authenticate 707 terminal device 105A and authorize the connection. The OC server 145 determines 709 if the connection by terminal device 105A is authorized. If the authentication is unsuccessful, then the OC server 145 tears 711 down the newly created path. If authorization is successful, OC server 145 establishes and maintains a path to terminal device 105D via WLAN 130. OC server 145 remains a network anchor point for the communication path between terminal device 105A and terminal device 105D until terminal device 105A or interworking network 115 releases the connection.

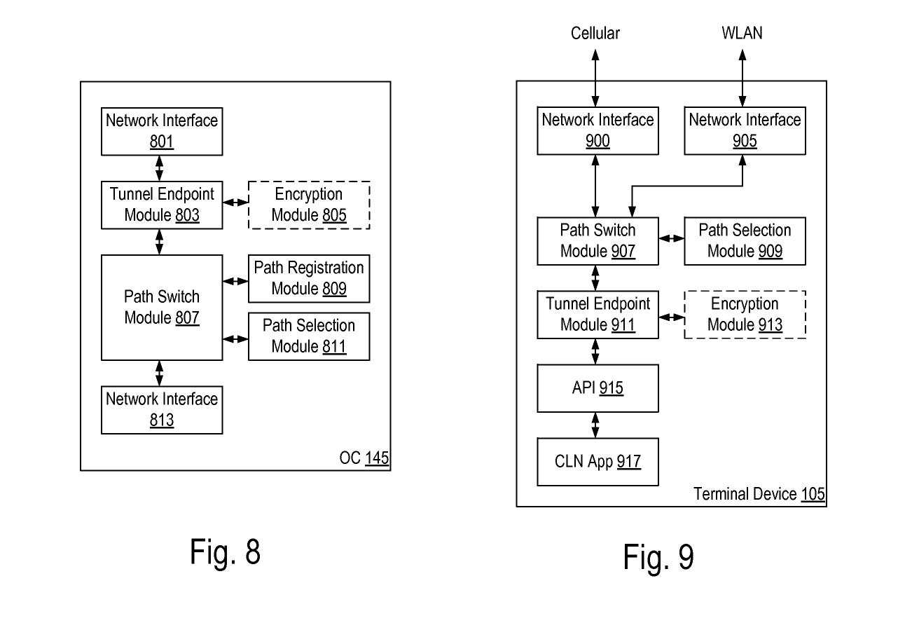

FIG. 8 is a block diagram of an embodiment of OC server 145 of FIG. 1. FIG. 8 illustrates the functional modules other than the contact manager 201 and contact database 203 shown in FIG. 2. OC server 145 includes a network interface 801 to communicate with terminal device 105 via one or more defined communication paths. A tunnel endpoint module 803 ensures the integrity of data passed between OC server 145 and terminal device 105. In a packet-switched network, tunnel endpoint module 803 buffers and reorders packets, checks for errors, and requests retransmission as necessary. These actions are conventional, and the list of actions is not exhaustive. OC server 145 may additionally support encryption/decryption module 805 to provide secure connections.

A path switch module 807 manages data flow for one or multiple paths defined between OC server 145 and terminal device 105. Path switch module 807 is controlled by path registration module 809 and path selection module 430. Path registration module 809 stores information used to define the communication path or paths. Path selection module 811 includes information upon which OC server 145 bases decisions regarding path preferences. Path selection module 811 may be programmed, for example, to achieve a desired minimum bandwidth or to achieve a maximum Internet bandwidth without exceeding a specified cost-per-byte. Whatever paths are specified, a second network interface 813 manages communication with terminal devices. Note that in alternative embodiments, multiple types of networks may be utilized to provide improved compatibility rather than switching between different types of networks.

FIG. 9 is a block diagram of terminal device 105, which includes a cellular network interface 900 and a WLAN interface 905. Cellular network interface 900 can support any of the conventional cellular protocols, such as code-division multiple access (CDMA) or High Spend Packet Access (HSPA), or may be extended to other conventional or later adopted wireless protocols, such as whitespace radio. Network interface 905 can likewise support conventional protocols, such as WiFi or WiMax, or may be extended to other protocols.

Terminal device 105 additionally includes a path switch module 907 and path selection module 909, which together select one or both interfaces 900 and 905 for communication. A tunnel endpoint module 911 ensures data integrity in the manner of tunnel endpoint module 803 of FIG. 8, and may likewise include encryption/decryption functionality provided by encryption module 913. An application programming interface (API) 915 provides a data interface between the tunnel endpoint module and a client application 917 for communication with OC server 145.

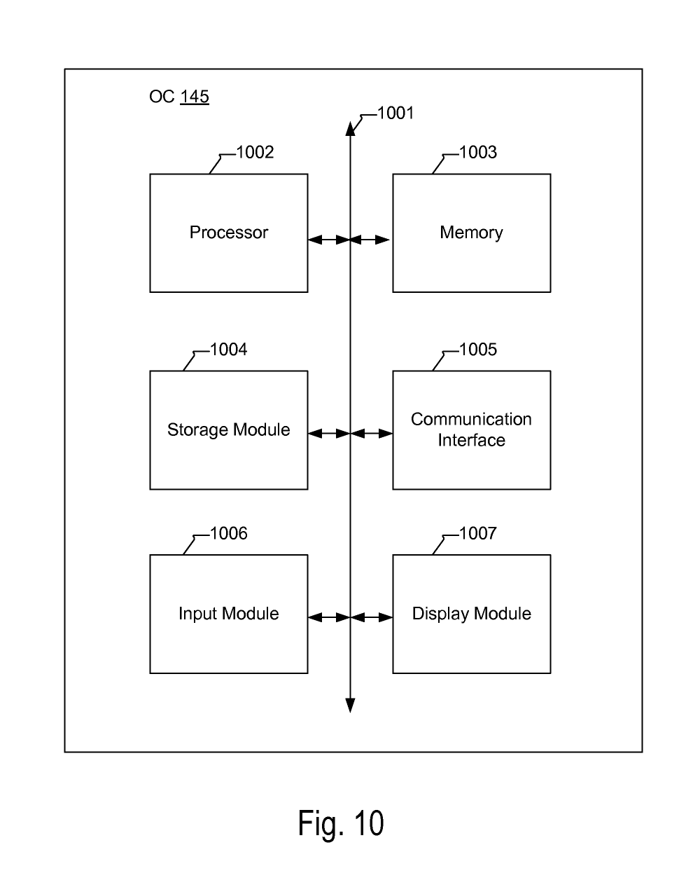

FIG. 10 illustrates the hardware architecture of OC server 145, according to one embodiment. In one embodiment, the OC server 145 is a server computer including components such as a processor 1002, a memory 1003, a storage module 1004, an input module (e.g., keyboard, mouse, and the like) 1006, a display module 1007, and a communication interface 1005, exchanging data and control signals with one another through a bus 1001. The storage module 1004 is implemented as one or more non-transitory computer readable storage medium (e.g., hard disk drive), and stores software that is run by the processor 1002 in conjunction with the memory 1003 to implement the OC server functionality according to embodiments of the present disclosure as illustrated herein. Operating system software and other application software may also be stored in the storage device 1004 to run on the processor 1002. Note that not all components of the OC server 145 are shown in FIG. 10 and that certain components not necessary for illustration of the present invention are omitted herein.

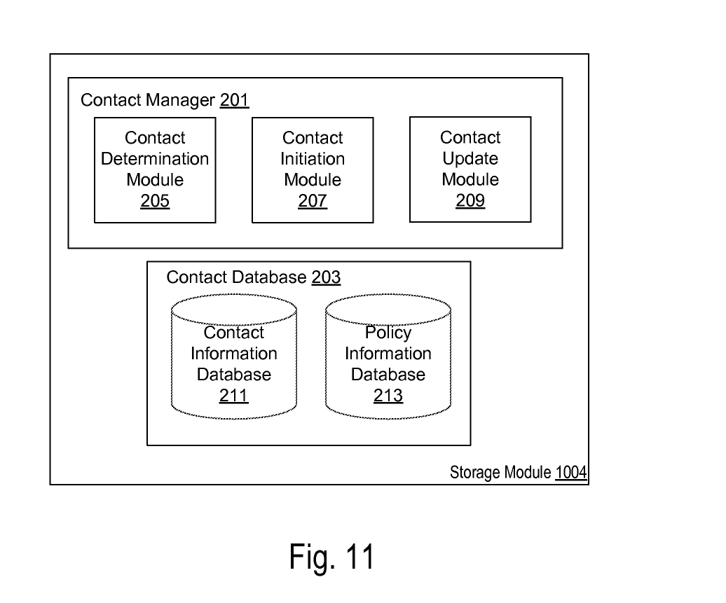

FIG. 11 illustrates the storage module 1004 of OC server 145 storing various software modules of the OC server 145, including a contact manager 201 comprising a contact determination module 204, a contact initiation module 207, and a contact update module 209 and a contact database 203 comprising a contact information database 211 and a policy information database 213.

Upon reading this disclosure, those of ordinary skill in the art will appreciate still additional alternative structural and functional designs for managing contact information, through the disclosed principles of the present disclosure. Thus, while particular embodiments and applications of the present disclosure have been illustrated and described, it is to be understood that the disclosure is not limited to the precise construction and components disclosed herein. Various modifications, changes and variations which will be apparent to those skilled in the art may be made in the arrangement, operation and details of the method and apparatus of the present disclosure disclosed herein without departing from the spirit and scope of the disclosure as defined in the appended claims.

1. In a server for facilitating communication between a first client associated with a first terminal device of a first user and a second client associated with a second terminal device of a second user, a computer-implemented method performed by a computer, the method comprising:
receiving from the first client a request to establish communication with the second user, the request being received via a first type of communication network; and
establishing communication between the server and a second client associated with the second user via a second type of communication network that is distinct from the first type of communication network and selected according to a user policy of the second user.

2. The computer-implemented method of claim 1, wherein the first type of communication network comprises a cellular telephone network and the second type of communication network comprises a wireless local area network.

3. (canceled)

4. The computer-implemented method of claim 1, wherein the server receives the request in a telephone call using the first type of communication network and sends an email message to the second client using the second type of communication network.

5. The computer-implemented method of claim 1, further comprising:
selecting the second type of communication network based on a plurality of communication mechanisms that are used to communicate with the second user as indicated in the user policy of the second user.

6. The computer-implemented method of claim 5, wherein the plurality of communication mechanisms comprises one or more of telephone calls, voice over internet protocol calls, instant messages, and email messages.

7. The computer-implemented method of claim 1, further comprising:
determining the first user's preferred communication identifier according to a user policy of the first user; and
providing the first user's preferred communication identifier to the second terminal device.

8. The computer-implemented method of claim 1, further comprising:
determining the second user's preferred communication identifier according to the user policy of the second user prior to receiving the request from the first client; and
providing the second user's preferred communication identifier to the first client, the request received from the first client including the second user's preferred communication identifier.

9. The computer-implemented method of claim 1, wherein establishing communication between the server and the second client comprises:
transmitting an instruction to the first client to contact the second client using a communication identifier selected according to the user policy of the second user responsive to being unable to establish communication with the second client.

10. In a server for facilitating communication between a first client associated with a first terminal device of a first user and a second client associated with a second terminal device of a second user, a computer-implemented method performed by a computer, the method comprising:
receiving from the first client a request to communicate with the second user, the request including a first portion indicative of a communication mechanism that uses a first type of communication network for communication and a second portion including a communication identifier of the second user that is associated with a second type of communication network that is distinct from the first type of communication network used by the communication mechanism;
resolving the second client based on the communication identifier of the second user associated with the second type of communication network;
establishing communication with the first client thereby allowing the first client to communicate with the second client; and
establishing communication with the second client thereby allowing the second client to communicate with the first client.

11. The computer-implemented method of claim 10, wherein the first portion indicates a telephone call communication mechanism and the second portion includes an email address.

12. The computer-implemented method of claim 10, wherein establishing communication with the first client comprises establishing communication using the first type of communication network and wherein establishing communication with the second client comprises establishing communication with the second client using the first type of communication network.

13. The computer-implemented method of claim 10, wherein establishing communication with the first client comprises establishing communication using the first type of communication network and wherein establishing communication with the second client comprises establishing communication with the second client using a third type of communication network.

14. The computer-implemented method of claim 10, wherein establishing communication with the first client comprises establishing communication using the first type of communication network and wherein establishing communication with the second client comprises establishing communication with the second client using the second type of communication network.

15. A non-transitory computer-readable storage medium comprising computer executable code for facilitating communication between a first client associated with a terminal device of a first user and a second client associated with a terminal device of a second user, the code when executed by a computer processor performs the steps comprising:
receiving from the first client a request to establish communication with the second user, the request being received via a first type of communication network; and
establishing communication between the server and a second client associated with the second user via a second type of communication network that is distinct from the first type of communication network and selected according to a user policy of the second user.

16. The computer-readable storage medium of claim 15, wherein the first type of communication network comprises a cellular telephone network and the second type of communication network comprises a wireless local area network.

17. (canceled)

18. The computer-readable storage medium of claim 15, wherein the server receives the request in a telephone call using the first type of communication network and sends an email message to the second client using the second type of communication network.

19. The computer-readable storage medium of claim 15, further comprising executable code when executed by the computer processor performs the steps of:
selecting the second type of communication network based on a plurality of communication mechanisms that are used to communicate with the second user as indicated in the user policy of the second user.

20. The computer-readable storage medium of claim 19, wherein the plurality of communication mechanisms comprises one or more of telephone calls, voice over internet protocol calls, instant messages, and email messages.

21. The computer-readable storage medium of claim 15, further comprising executable code when executed by the computer processor performs the steps of:
determining the first user's preferred communication identifier according to a user policy of the first user; and
providing the first user's preferred communication identifier to the second terminal device.

22. The computer-readable storage medium of claim 15, further comprising executable code when executed by the computer processor performs the steps of:
determining the second user's preferred communication identifier according to the user policy of the second user prior to receiving the request from the first client; and
providing the second user's preferred communication identifier to the first client, the request received from the first client including the second user's preferred communication identifier.

23.-39. (canceled)
